(19) United States
(12) Patent Application Publication
(10) Pub. No.: US 2007/0036380 A1
(43) Pub. Date: Feb. 15, 2007

(54) Hearing device with program switch and programming socket

(76) Inventors: Holger Kral, Erlangen (DE); Michael Sattler, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/502,489

(22) Filed: Aug. 10, 2006

(30) Foreign Application Priority Data
Aug. 10, 2005 (DE) 10 2005 037 897.8

(51) Int. Cl. H04R 25/00

(52) U.S. Cl. 381/324; 381/322

(57) ABSTRACT

The layout of a programmable hearing device and especially of a programmable hearing aid is to be simplified. To this end there is provision for a one-piece cover unit to cover both a program switch and also a programming socket. The cover unit has a locking element with which, in the closed state, it is held over the program switch and the programming socket. Furthermore the cover unit can be moved slightly in its closed state, so that the program switch is able to be actuated by the movement. This means that the cover unit serves not only to cover the program switch and the programming socket, but also to actuate the programming switch.

### CROSS REFERENCE TO RELATED APPLICATIONS

This application claims priority of German application No. 10 2005 037 897.8 filed Aug. 10, 2005, which is incorporated by reference herein in its entirety.

### FIELD OF THE INVENTION

The present invention relates to a hearing device, especially a hearing aid, with a program switch to switch into a number of hearing programs, and a programming socket for connecting the hearing device to a programming device.

### BACKGROUND OF THE INVENTION

Numerous hearing devices are provided with the facility for selecting different hearing programs. To this end they have a pushbutton switch which allows the individual programs to be selected at the push of a button.

In addition modern hearing aids generally posses a programming interface via which individual programming is possible. The programming interface is mostly realized as a programming socket or a programming contact.

The pushbutton switch for program selection usually needs a separate control since it is generally very small. A plastic button which presses on a membrane switch is frequently used for this purpose. The button simultaneously represents a cover and a protection for the membrane switch.

A further cover is provided as a rule for the programming socket. This serves to keep the electrical contacts of the programming circuit free from contamination.

A behind-the-ear hearing device is known in this context from DE 296 02 921 U1 which features a covering device for the programming socket and a pushbutton. The covering device is embodied a hinged flap and additionally features a mounting with a cutout for a control.

In addition a programmable hearing aid is known from publication DE 88 00 629 U1 or publication EP 0 591 791 B1 in which the programming socket can be covered by a simple flap

### SUMMARY OF THE INVENTION

The object of the present invention is to simplify the design of a hearing device or a hearing aid.

In accordance with the invention this object is achieved by a hearing device, especially a hearing aid, with a program switch to switch into a number of hearing programs and a programming socket for connecting the hearing device to a programming device, as well as a cover unit which is embodied in one piece and covers both the program switch and the programming socket, with the covering device having a locking element, with which it is retained in the closed state over the program switch and the programming socket so that it can be removed, and with the cover unit able to be moved slightly in the closed state so that the program switch can be actuated by its movement.

Advantageously the inventive solution saves on one plastic part, since the cover unit has multiple functionality. On the one hand it covers both the programming switch and also the programming socket and on the other hand it is also used for actuation of the program switch. Consequently one fewer injection molding tool needs to be manufactured for hearing aid production, and in manufacturing as well as in service one fewer part needs to be handled.

Preferably the cover unit is supported on a hinge on the housing of the hearing device. This type of support is simple to implement and to install.

In accordance with a further development the cover unit on the distal i.e. free end in relation to the pivot axis features a touch section, and the program switch lies in the closed state between the pivot axis and the touch section, so that a pressure on the touch section magnifies a pressure on the program switch through a lever action. In this way the operating convenience of the hearing device can be increased.

In accordance with an alternate embodiment the cover unit can be supported to enable it to slide on the housing of the hearing device, so that the program switch can be actuated by a sliding movement of the cover unit. Such a slider would possible have the advantage over a flap of reducing the danger of loss or damage to it when the programming socket is uncovered.

The locking element is usefully a snap-in element. This allows a releasable lock to be implemented in a very simple manner.

Furthermore the programming switch can be implemented by a membrane switch. Such a membrane switch represents a low-cost standard component.

### BRIEF DESCRIPTION OF THE DRAWINGS

The invention will now be explained in more detail on the basis of the enclosed drawings, which show:

FIG. 1 a behind-the-ear hearing aid with an inventive cover unit;

FIG. 2 a section through hearing device shown in FIG. 1 at the control; and

FIG. 3 the section from FIG. 1, with the control unit shown with the cover unit open.

### DETAILED DESCRIPTION OF THE INVENTION

The exemplary embodiments described in greater detail below represent preferred embodiments of the present invention.

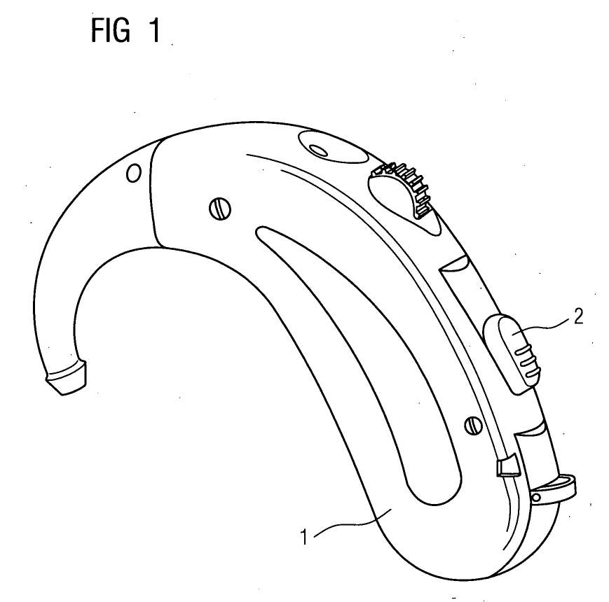

The behind-the-ear hearing aid shown in FIG. 1 has a cover unit 2 on the surface of the hearing aid shell 1 which simultaneously serves as a control for a switch located below it.

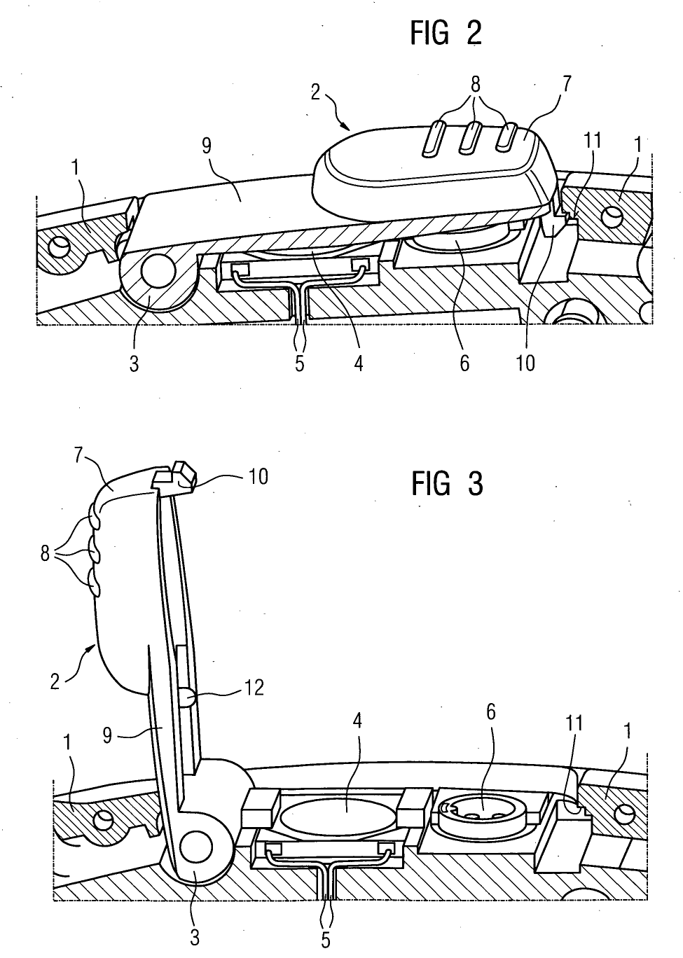

An enlarged view of the cover unit 2 is shown in FIG. 2 and the hearing aid shell 1 is shown cut away. The cover unit 2 is mounted on a hinged support 3.

Below the cover unit 2 a membrane switch 4 can be seen which serves as a program switch. It is connected via a cable 5 to a signal processing unit or the hearing device not shown in the drawing.

Below the control 2 there is also a programming socket 6, with which the hearing aid can be individually programmed.

The cover unit 2 is embodied in one piece, as an injection-molded part in this case. It features a hinged support section 3, and at its free end a raised control section 7 with ridges 8 to make it easier to grip. There is space below the raised control section 7 which is embodied as a bell shape, for the programming socket 6 in the closed state shown in FIG. 2. Furthermore a cover section 9 is located between the hinged support section and the operating section 7. The membrane switch 4 is arranged below this cover section 9.

At the outermost free end of the cover unit 2, i.e. at the tip of the control section, there is a molded-on hook 10. In the closed state of the cover unit shown in FIG. 2, this hook 10 engages under a shoulder 11 of the hearing aid shell 1. The hook 10 is embodied as a snap-in element and locks the cover unit 2 in the closed position. The hook 10 can be pressed back with a small screwdriver for example so that the cover unit 2 can be hinged open.

The cover unit 2 can be opened by least 90 degrees around the hinged support 3. This results in the position illustrated in FIG. 3. In the hinged-open state the programming connector can be plugged into the programming socket 6. Once programming is completed, the cover unit 2 is pushed back into the closed position, with the hook 10 snapping under the shoulder 11.

In the opened state shown in FIG. 3 a lug can be seen on the underside of the cover section 9 of the cover unit 2, which in the closed state is arranged directly above the membrane switch 4 but does not touch the latter or only touches it very slightly. To actuate the membrane switch 4 the cover unit 2 can now be moved slightly downwards in the direction of the membrane switch 4. When this is done the lug 12 on the underside of the cover unit 2 presses onto the membrane switch 4. The force exerted on the membrane switch 4 is increased in this case by the lever effect. In the present case the force exerted on the membrane switch 4 is approximately double the force exerted on the control section 7.

The cover unit 2 thus has the following functionalities:

Covering the program switch,

Covering the programming socket,

Control for the program switch and

Transferring the actuation force for the program switch.

1-6. (canceled)

7. A hearing device with a housing, comprising:
a program switch arranged on the housing that switches the hearing device into a plurality of hearing programs;
a programming socket arranged on the house that connects the hearing device to a programming device;
a cover unit arranged on the housing that covers the program switch and the programming socket in a closed configuration; and
a locking element arranged on the cover unit that retains the cover unit in the closed configuration and allows the cover unit to be opened,
wherein the program switch is actuated by moving the cover unit in the closed configuration.

8. The hearing device as claimed in claim 7, wherein the cover unit is support on a hinge in the housing of the hearing device.

9. The hearing device as claimed in claim 8, wherein the cover unit comprises a touch section at a distal end of the pivot axis and the program switch is located in the closed configuration between the pivot axis and the touch section.

10. The hearing device as claimed in claim 9, wherein the cover unit is pressed and the touch section passes and increases the pressure on the program switch through a lever action to actuate the program switch.

11. The hearing device as claimed in claim 7, wherein the cover unit slides on the housing of the hearing device and the program switch is actuated through a sliding movement of the cover unit.

12. The hearing device as claimed in claim 7, wherein the locking element is a snap-in element.

13. The hearing device as claimed in claim 7, wherein the program switch is a membrane switch.

14. The hearing device as claimed in claim 7, wherein the cover unit is one piece.

15. The hearing device as claimed in claim 14, wherein the cover unit is plastic.

16. The hearing device as claimed in claim 7, wherein the hearing device is a hearing aid.

17. A method for a hearing device with a housing, comprising:
arranging a program switch on the housing for switching the hearing device into a plurality of hearing programs;
arranging a programming socket on the housing for connecting the hearing device to a programming device;
arranging a cover unit on the housing for covering the program switch and the programming socket in a closed configuration;
arranging a locking element on the cover unit for retaining the cover unit in the closed configuration and allowing the cover unit to be lifted up; and
actuating the program switch by moving the cover unit in the closed configuration.
